(19) United States
(12) Patent Application Publication
(10) Pub. No.: US 2026/0343080 A1
(43) Pub. Date: Oct. 29, 2026

(54) LENS BARREL AND IMAGING DEVICE EQUIPPED WITH SAME

(71) Applicant: Panasonic Intellectual Property Management Co., Ltd., Osaka (JP)

(72) Inventor: Daisuke ITO, Osaka (JP)

(73) Assignee: Panasonic Intellectual Property Management Co., Ltd., Osaka (JP)

(21) Appl. No.: 19/644,053

(22) Filed: Apr. 10, 2026

(30) Foreign Application Priority Data
Apr. 23, 2025 (JP) 2025-071116

(51) Int. Cl. H04N 23/55; G02B 7/02; G02B 7/10; G03B 17/12

(52) U.S. Cl. CPC H04N 23/55; G02B 7/021; G02B 7/023; G02B 7/10; G03B 17/12

(57) ABSTRACT

A lens barrel 10 includes a lens L2, a second lens group unit 12, a rectilinear guide cylinder 15, an adjustment pin 12c, a cam follower 12b, a cam barrel 20, and a through-hole 22c. The adjustment pin 12c is used to perform work on the second lens group unit 12 from the radial outside using a specific tool. The cam barrel 20 has a plurality of cam grooves 21 to 25 that are provided to a substantially cylindrical main body portion 20a and include a cam groove 22 that moves the second lens group unit 12 in the optical axis direction when the cam follower 12b engages and rotates relative to the rectilinear guide cylinder 15. The through-hole 22c is provided at a position communicating with a cam groove 22 in the main body portion 20a of the cam barrel 20, and is disposed at a position overlapping the adjustment pin 12c when viewed from the radial outside centered on the optical axis AX in a state in which work is being performed on the second lens group unit 12.

### CROSS-REFERENCE TO RELATED APPLICATIONS

This application claims priority to Japanese Patent Application No. 2025-071116 filed on Apr. 23, 2025. The entire disclosure of Japanese Patent Application No. 2025-071116 is hereby incorporated herein by reference.

### BACKGROUND

### Technical Field

The present disclosure relates to a lens barrel, and to an imaging device equipped with this lens barrel.

### Description of the Related Art

For example, Patent Literature 1 discloses a lens barrel that includes a first adjustment mechanism for adjusting the position of a second lens frame in the optical axis direction with respect to a first lens frame by moving the second lens frame in the optical axis direction relative to the first lens frame, and a second adjustment mechanism for adjusting the position of the second lens frame in the radial direction with respect to the first lens frame by moving the second lens frame in the radial direction perpendicular to the optical axis direction with respect to the first lens frame.

With this lens barrel, the position of the second lens frame in the optical axis direction relative to the first lens frame is adjusted by a rotation frame that is rotatably held by the first lens frame, and the radial position of the second lens frame relative to the first lens frame is adjusted by an adjustment screw that engages with a screw hole in the first lens frame.

### CITATION LIST

### Patent Literature

Patent Literature 1: JP-A 2022-165472

### SUMMARY

### Problem to be Solved by the Invention

However, the following problem is encountered with the conventional lens barrel described above.

With the lens barrel disclosed in the above publication, a through-hole is provided in the cam barrel to allow various kinds of work to be performed from the outer peripheral side on a lens frame disposed on the inner peripheral side of a cam barrel or rectilinear guide cylinder, such as adjusting the position in a plane perpendicular to the optical axis, adjusting the inclination relative to the optical axis, tightening a screw, or adhesive bonding.

Here, With a typical cam barrel configuration, a minimum thickness must be ensured between the cam groove and the through-hole used for working so that the cam barrel with have the required strength.

The thickness referred to here means both the thickness of the cam barrel and the distance between a cam groove and a through-hole that are adjacent on the outer peripheral surface of the cam barrel.

Therefore, when through-holes are provided for the working of a plurality of lens frames, there is less latitude in the layout of the cam grooves and the through-holes used for the work, and the cam barrel ends up being larger in order to ensure the minimum required wall thickness, so a problem was that this made is more difficult to obtain a more compact lens barrel.

It is an object of the present disclosure to provide a lens barrel with which an increase in the size of the lens barrel can be avoided while still ensuring the strength of the cam barrel provided with a through-hole for working, as well as an imaging device equipped with this lens barrel.

### Means for Solving Problem

The lens barrel according to the present disclosure includes a first lens group, a first lens frame, a rectilinear guide cylinder, a working portion, a first cam follower, a cam barrel, and a through-hole. The first lens group has at least one lens. The first lens frame holds the first lens group. The rectilinear guide cylinder has a substantially cylindrical first main body portion that surrounds the first lens frame, and a rectilinear groove formed in the optical axis direction so as to pass through the first main body portion, and supports the first lens frame so as to be movable in the optical axis direction. The working portion is provided to the first lens frame, and work is performed on the first lens frame from the radial outside centered on the optical axis using a specific tool. The first cam follower is provided to the first lens frame and protrudes outward in the radial direction centered on the optical axis. The cam barrel has a substantially cylindrical second main body portion that surrounds the first lens frame, and a plurality of cam grooves including a first cam groove that is provided to the second main body portion and moves the first lens frame in the optical axis direction when the first cam follower engages and rotates relative to the rectilinear guide cylinder. The through-hole is provided at a position communicating with the cam groove in the second main body portion of the cam barrel, and is disposed so as to overlap the working portion when viewed from the radial outside centered on the optical axis when in a state of working on the first lens frame.

### Effects

With the lens barrel of the present disclosure, it is possible to avoid an increase in the size of the lens barrel while ensuring the strength of a cam barrel provided with a through-hole for working.

### BRIEF DESCRIPTION OF THE DRAWINGS

FIG. 1 is an overall oblique view showing a state in which the lens barrel according to an embodiment of the present disclosure has been removably attached to a camera body;

FIG. 2 is an oblique view of the configuration of the lens barrel in FIG. 1;

FIG. 3 is an exploded oblique view of the configuration of the lens barrel in FIG. 1;

FIG. 4 is an oblique view of the configuration of the cam barrel included in the lens barrel in FIG. 3;

FIG. 5 is a developed view showing the layout of cam grooves of the cam barrel in FIG. 4;

FIG. 6 is a cross-sectional view of a section including an adjustment pin of a second lens group frame in a state in which the lens barrel in FIG. 2 is at the wide-angle end and it is difficult for a tool or the like to access the adjustment pin from the outer peripheral side;

FIG. 7 is a cross-sectional view of a section including the adjustment pin of the second lens group frame in a state in which the lens barrel in FIG. 2 is at the telephoto end and it a tool or the like is able to access the adjustment pin from the outer peripheral side;

FIG. 8A is a side view of the outer peripheral surface of the cam barrel as viewed from in normal direction of the adjustment pin of the second lens group unit, in a state in which the lens barrel in FIG. 2 is in the telephoto position;

FIG. 8B is a side view showing a state in which the first lens group frame has been removed in FIG. 8A;

FIG. 9 is a cross-sectional view of a section including the adjustment pin of a third lens group frame in a state in which the lens barrel in FIG. 2 is at the wide angle end and the adjustment pin can be accessed by a tool or the like from the outer peripheral side;

FIG. 10A is a side view of the outer peripheral surface of the cam barrel as viewed in the normal direction of the adjustment pin of the third lens group unit in a state in which the lens barrel in FIG. 2 is in the wide angle position;

FIG. 10B is a side view showing a state in which the first lens group frame has been removed in FIG. 10A;

FIG. 11 is a cross-sectional view of a section including the adjustment pins of fourth and fifth lens group frames, in a state in which the lens barrel in FIG. 2 is at the telephoto end and the adjustment pin can be accessed by a tool or the like from the outer peripheral side;

FIG. 12A is a side view of the outer peripheral surface of the cam barrel as viewed in the normal direction of the adjustment pins of the fourth and fifth lens group unit in a state in which the lens barrel in FIG. 2 is in the telephoto position; and

FIG. 12B is a side view showing a state in which the first lens group frame has been removed in FIG. 12A.

### DETAILED DESCRIPTION OF THE EMBODIMENT

Embodiments will now be described in detail through reference to the drawings. However, some unnecessarily detailed description may be omitted. For example, detailed description of already known facts or redundant description of components that are substantially the same may be omitted. This is to avoid unnecessary repetition in the following description, and facilitate an understanding on the part of a person skilled in the art.

The applicant has provided the appended drawings and the following description so that a person skilled in the art might fully understand this disclosure, but does not intend for these to limit what is discussed in the patent claims.

### Embodiment 1

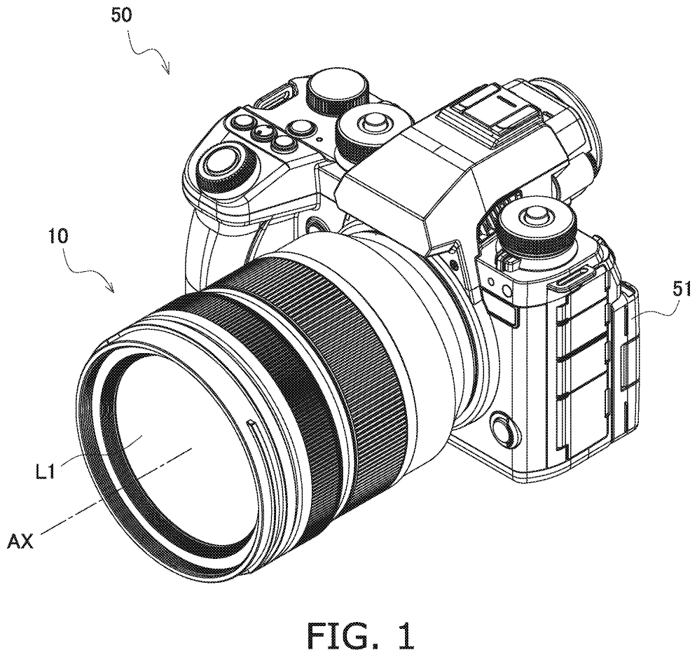

A lens barrel 10 according to an embodiment of the present disclosure and a camera (imaging device) 50 including this lens barrel will now be described with reference to FIGS. 1 to 12B.

### (1) Configuration of Camera 50

As shown in FIG. 1, a camera (imaging device) 50 according to this embodiment includes a lens barrel 10 and a camera body 51.

The lens barrel 10 is removably attached to the camera body 51. The configuration of the lens barrel 10 will be described in detail below.

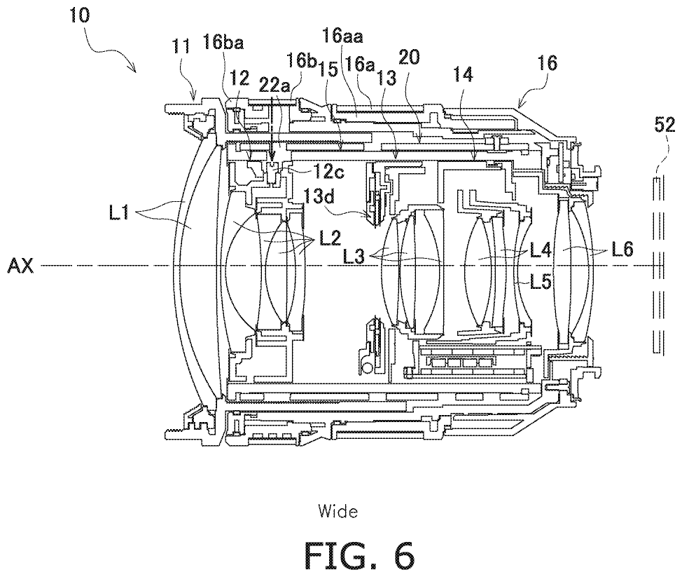

The camera body 51 captures an image of a subject through the lens barrel 10 using an image sensor 52 (see FIG. 6, etc.) mounted inside, and generates image data.

### (2) Overall Configuration of Lens Barrel 10

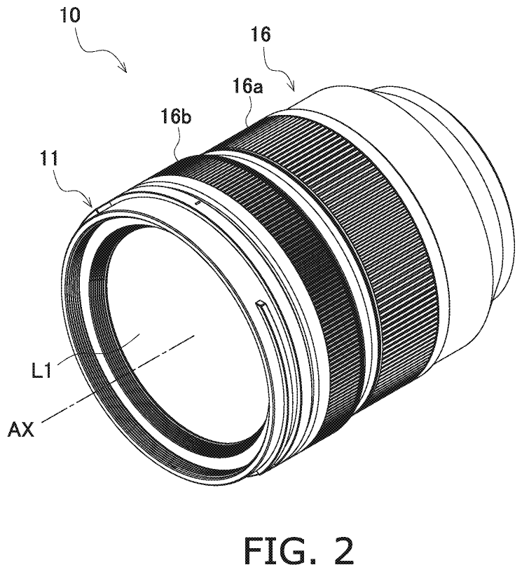

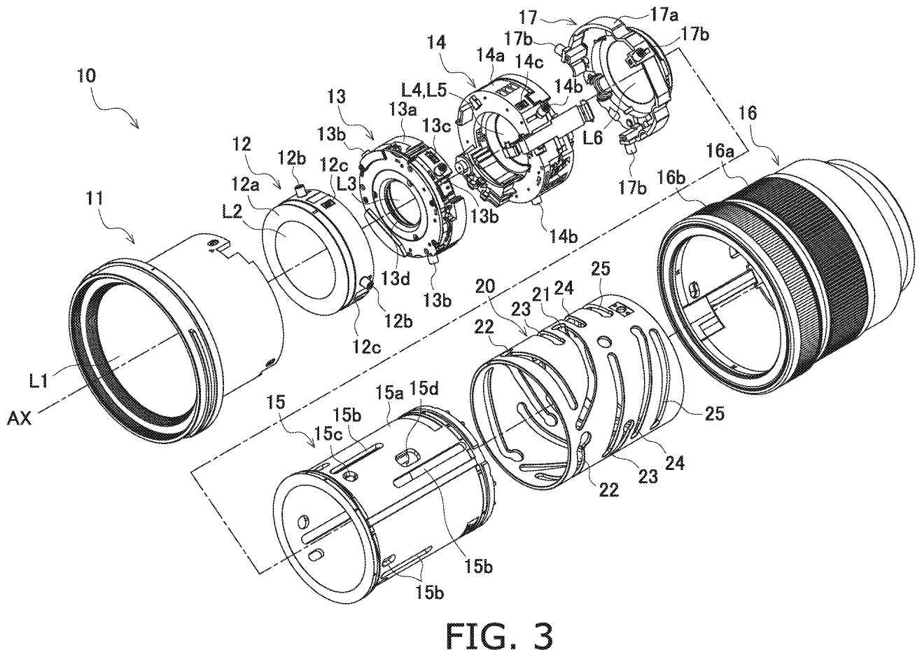

The lens barrel 10 according to this embodiment is detachably attached to the camera body 51. As shown in FIGS. 2 and 3, the lens barrel 10 includes a first lens group unit (second lens frame) 11, a second lens group unit (first lens group frame) 12, a third lens group unit 13, a fourth and fifth lens group unit (first lens group frame) 14, a sixth lens group unit 17, a rectilinear guide cylinder 15, a cam barrel 20, and an exterior unit 16.

As shown in FIGS. 2 and 3, the first lens group unit (second lens frame) 11 is a substantially cylindrical member that is disposed the closest to the subject in the optical axis AX direction out of all the components that make up the lens barrel 10, and holds a lens L1 on its inner peripheral surface. The first lens group unit 11 has a cam follower (not shown) that moves while engaged with a cam groove (second cam groove) 21 of the cam barrel 20 (discussed below), and is moved back and forth in the optical axis AX direction as the cam barrel 20 rotates relative to the rectilinear guide cylinder 15.

As shown in FIG. 3, the second lens group unit (second lens frame) 12 holds a lens L2, and moves back and forth in the optical axis AX direction on the inner peripheral surface side of the rectilinear guide cylinder 15 along with the relative rotation of the cam barrel 20 with respect to the rectilinear guide cylinder 15. The second lens group unit 12 has a substantially cylindrical main body portion 12a, cam followers (second cam followers) 12b that protrude outward in the radial direction centered on the optical axis AX, and an adjustment pin (working portion) 12c.

Three cam followers 12b are disposed at substantially equal angular intervals (approximately 120 degrees) on the outer peripheral surface of the substantially cylindrical main body portion 12a. The cam followers 12b move while engaged with cam grooves 22 of the cam barrel 20 (discussed below), and this moves the second lens group unit 12 back and forth in the optical axis AX direction as the cam barrel 20 rotates relative to the rectilinear guide cylinder 15.

The adjustment pins (working portions) 12c are part that adjust the position of the second lens group unit 12 in a plane perpendicular to the optical axis AX and the inclination with respect to the optical axis AX, and three of them are provided at substantially equal angular intervals (approximately 120 degrees) on the outer peripheral surface of the substantially cylindrical main body portion 12a. The adjustment pins 12c are adjusted using a specific tool or the like that is inserted from the outer peripheral side in the radial direction centered on the optical axis AX.

As shown in FIG. 3, the third lens group unit 13 holds a lens L3, and has a substantially cylindrical main body portion 13a, cam followers 13b, adjustment pins 13c, and an aperture unit 13d.

Three cam followers 13b are disposed at substantially equal angular intervals (approximately 120 degrees) on the outer peripheral surface of the substantially cylindrical main body portion 13a. The cam followers 13b move while engaged with cam grooves 23 of the cam barrel 20 (discussed below), and this moves the third lens group unit 13 back and forth in the optical axis AX direction as the cam barrel 20 rotates relative to the rectilinear guide cylinder 15.

Three adjustment pins 13c are provided at substantially equal angular intervals (approximately 120 degrees) on the outer peripheral surface of the substantially cylindrical main body portion 13a. Adjustment pins 13c are adjusted using a specific tool or the like that is inserted from the outside in the radial direction (outer peripheral side) centered on the optical axis AX.

The aperture unit 13d is disposed on the subject side of the main body portion 13a in the optical axis AX direction, and adjusts the amount of light incident from the subject side that passes through the lens barrel 10 by opening and closing aperture blades (not shown) to change the aperture surface area.

The fourth and fifth lens group unit (first lens group frame) 14 is, for example, a linear focus unit that adjusts the focal length by moving the fourth and fifth lens group lenses L4 and L5, such as surrounded focus lenses, back and forth in the optical axis AX direction when a focus ring 16ba rotatably attached to the outer peripheral surface of the exterior unit 16 is turned. As shown in FIG. 3, the fourth and fifth lens group unit 14 holds the lenses L4 and L5 and has a substantially cylindrical main body portion 14a, cam followers (first cam followers) 14b, and adjustment pins 14c.

Three cam followers (first cam followers) 14b are disposed at substantially equal angular intervals (approximately 120 degrees) on the outer peripheral surface of the approximately cylindrical main body portion 14a. The cam followers 14b move while engaged in the cam grooves 24 of the cam barrel 20 (discussed below), thereby moving the fourth and fifth lens group unit 14 back and forth in the optical axis AX direction as the cam barrel 20 rotates relative to the rectilinear guide cylinder 15.

The adjustment pins 14c are components for adjusting the position of the fourth and fifth lens group unit 14 in a plane perpendicular to the optical axis AX and the inclination with respect to the optical axis AX, and three of these are provided at substantially equal angular intervals (approximately 120 degrees) on the outer peripheral surface of the substantially cylindrical main body portion 14a. The adjustment pins 14c are adjusted using a specific tool or the like that is inserted from the outside in the radial direction (outer peripheral side) centered on the optical axis AX.

As shown in FIG. 3, the sixth lens group unit 17 holds the lens L6, and moves back and forth in the optical axis AX direction on the inner peripheral surface side of the rectilinear guide cylinder 15 as the cam barrel 20 rotates with respect to the rectilinear guide cylinder 15. The sixth lens group unit 17 has a substantially cylindrical main body portion 17a and cam followers 17b that protrude outward in the radial direction centered on the optical axis AX.

Three cam followers 17b are disposed at substantially equal angular intervals (approximately 120 degrees) on the outer peripheral surface of the substantially cylindrical main body portion 17a. The cam followers 17b move while engaged with cam grooves 25 of the cam barrel 20 (discussed below), and this moves the sixth lens group unit 17 back and forth in the optical axis AX direction as the cam barrel 20 rotates relative to the rectilinear guide cylinder 15.

As shown in FIG. 3, the rectilinear guide cylinder 15 is a substantially cylindrical member disposed adjacent to the cam barrel 20 on the inner peripheral surface side, and the second lens group unit 12, the third lens group unit 13, the fourth and fifth lens group unit 14, and the sixth lens group unit 17 are disposed on the inner peripheral surface thereof. The rectilinear guide cylinder 15 has a substantially cylindrical main body portion 15a, rectilinear grooves 15b, and through-holes 15c and 15d.

The rectilinear grooves 15b are through-grooves formed along the optical axis AX direction, and move while engaged with the cam followers 12b, 13b, and 14b provided to the second lens group unit 12, the third lens group unit 13, the fourth and fifth lens group unit 14, the sixth lens group unit 17, etc.

The through-holes 15c are formed so that a specific tool or the like can access an adjustment pin 12c provided to the second lens group unit 12 (discussed below) from the outer peripheral side, and is disposed on the subject side in the optical axis AX direction.

The through-holes 15d are formed so that a specific tool or the like can access the adjustment pins 13c and 14c provided to the third lens group unit 13 and the fourth and fifth lens group unit 14 (discussed below) from the outer peripheral side, and is disposed in the optical axis AX near the approximate center of the substantially cylindrical main body portion 15a.

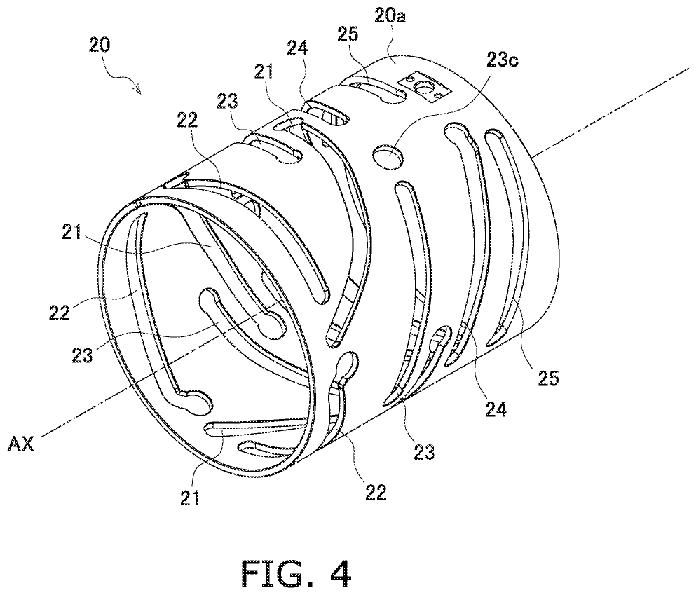

As shown in FIG. 3, the cam barrel 20 is a substantially cylindrical member made of aluminum, for example, and is disposed on the outer peripheral surface side of the rectilinear guide cylinder 15, and is turned relative to the rectilinear guide cylinder 15 to drive the second lens group unit 12, the third lens group unit 13, the fourth and fifth lens group unit 14, and the sixth lens group unit 17 back and forth in the optical axis AX direction. As shown in FIG. 4, the cam barrel 20 has a substantially cylindrical main body portion 20a and a plurality of cam grooves 21, 22, 23, 24, and 25 formed in the main body portion 20a.

The cam barrel 20 is configured by cutting the cam grooves 21, 22, 23, 24, and 25 into a substantially cylindrical aluminum member.

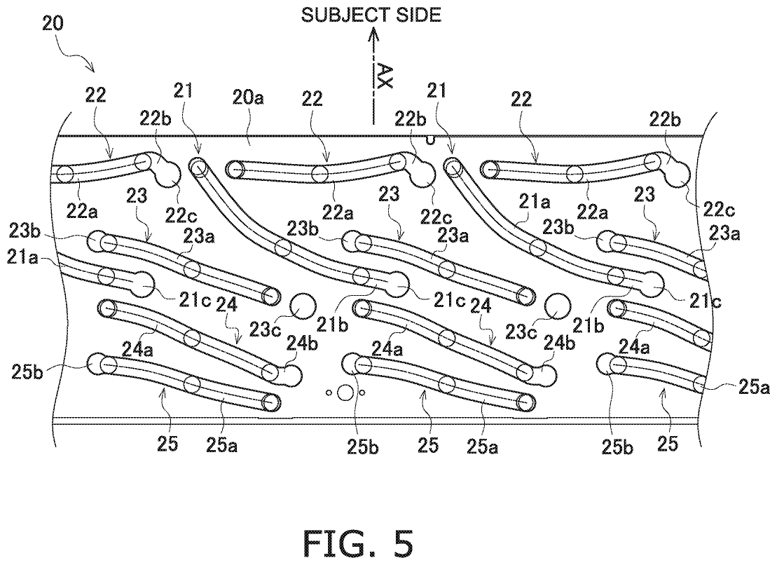

The cam grooves (second cam grooves) 21 are formed obliquely from the subject side to near the center of the substantially cylindrical main body portion 20a, and moves in a state of being engaged with a cam follower (not shown) provided to the first lens group unit 11. As shown in FIG. 5, the cam grooves 21 each have a cam movement region (third region) 21a, an unused region (fourth region) 21b, and a through-hole 21c.

The cam movement region (third region) 21a is the range over which a cam follower of the first lens group unit 11 engages and moves during imaging with the lens barrel 10, and is disposed running in a direction that intersects the optical axis AX in order to move the first lens group unit 11 a long distance in the optical axis AX direction.

The unused region (fourth region) 21b communicates with the cam movement region 21a, and is a region through which a cutting tool passes on its way from the cutting start point to the cam movement region 21a during the cutting of the cam groove 21. That is, the unused region 21b is a region through which a cam follower of first lens group unit 11 does not move during imaging with the lens barrel 10.

The through-holes 21c are provided so that a specific tool can access the adjustment pins 14c provided to the fourth and fifth lens group unit 14 from the outer peripheral surface side during adjustment of the fourth and fifth lens group unit 14 (discussed below). The through-holes 21c are located at the ends of the cam grooves 21, at a position that communicates with the unused region 21b. The through-holes 21c have a diameter (or width) that is greater than the width of the cam grooves 21. The through-holes 21c are formed so as to expand the diameter of a circle that is formed at the machining start point when cutting the cam grooves 21.

The diameter of the through-holes 21c may be appropriately set depending on the size of the specific tool used to access the adjustment pin 14c of the fourth and fifth lens group unit 14 (discussed below) from the outer peripheral surface side, the size of the adjustment pin 14c, and so forth.

The cam grooves (first cam grooves) 22 are formed on the subject side of the substantially cylindrical main body portion 20a, and move in a state of being engaged with a cam follower 12b provided to the second lens group unit 12. As shown in FIG. 5, cam grooves 22 each have a cam movement region (first region) 22a, an unused region (second region) 22b, and a through-hole 22c.

The cam movement region (first region) 22a is the range over which the cam follower 12b of the second lens group unit 12 engages and moves during imaging with the lens barrel 10, and is disposed in a direction substantially perpendicular to the optical axis AX.

The unused region (second region) 22b communicates with the cam movement region 22a, and is a region through which the cutting tool passes as it moves from the cutting start point to the cam movement region 22a during the cutting of the cam groove 22. That is, the unused region 22b is the region through which the cam follower 12b of the second lens group unit 12 does not move during imaging with the lens barrel 10.

The through-holes 22c are provided so that a specific tool can access the adjustment pins 12c provided to the second lens group unit 12 from the outer peripheral surface side when adjusting the second lens group unit 12 (discussed below). The through-hole 22c is located at the ends of the cam groove 22, at a position that communicates with the unused region 22b. The through-holes 22c have a diameter greater than the width of the cam grooves 22. The through-holes 22c are formed by expanding the diameter of a circle that is formed at the machining start point in the cutting of the cam grooves 22.

As with the through-holes 21c, the diameter of the through-holes 22c may be appropriately set depending on the size of the specific tool used to access the adjustment pin 12c of the second lens group unit 12 (discussed below) from the outer peripheral surface side, the size of the adjustment pin 12c, and so forth.

The cam grooves 23 are formed in the optical axis AX direction near the approximate center of the substantially cylindrical main body portion 20a, and moves in a state of being engaged with the cam followers 13b provided to the third lens group unit 13. As shown in FIG. 5, the cam grooves 23 each have a cam movement region 23a, an unused region 23b, and a through-hole 23c.

The cam movement region 23a is the range over which the cam follower 13b of the third lens group unit 13 engages and moves during imaging with the lens barrel 10, and is disposed running along a direction that intersects the optical axis AX.

The unused region 23b communicates with the cam movement region 23a, and is the region through which the cutting tool passes on its way from the cutting start point to the cam movement region 23a during the cutting of the cam grooves 23. That is, the unused region 23b is the region through which the cam follower 13b of the third lens group unit 13 does not move during imaging with the lens barrel 10.

The through-holes 23c are provided so that a specific tool can access the adjustment pin 13c provided to the third lens group unit 13 from the outer peripheral surface side when adjusting the third lens group unit 13 (discussed below). The through-holes 23c are disposed independently, each at a position away from the cam groove 23. The through-holes 23c have a diameter greater than the width of cam grooves 23.

As with the through-holes 21c and 22c, the diameter of the through-hole 23c may be appropriately set depending on the size of the specific tool used to access the adjustment pin 13c of the third lens group unit 13 (discussed below) from the outer peripheral surface side, the size of the adjustment pin 13c, and so forth.

The cam grooves 24 are formed in the substantially cylindrical main body portion 20a at a position more toward the opposite side from the subject side in the optical axis AX direction, and move in a state of being engaged with the cam followers 14b provided to the fourth and fifth lens group unit 14. As shown in FIG. 5, cam grooves 24 each have a cam movement region 24a and an unused region 24b.

The cam movement region 24a is the range over which the cam follower 14b of the fourth and fifth lens group unit 14 engages and moves during imaging with the lens barrel 10, and is disposed running along a direction that intersects the optical axis AX.

The unused region 24b communicates with the cam movement region 24a, and is the region in which the cutting tool moves from the cutting start point to the cam movement region 24a during the cutting of the cam grooves 24. That is, the unused region 24b is the region where the cam follower 14b of the fourth and fifth lens group unit 14 does not move during imaging with the lens barrel 10.

Here, the through-holes 21c formed to allow a specific tool to access the adjustment pin 14c of the fourth and fifth lens group unit 14 from the outer peripheral surface side are provided at the ends of the cam grooves 21 that drive the first lens group unit 11, as described above, rather than in the cam grooves 24 that drive the fourth and fifth lens group unit 14 in the optical axis AX direction.

The cam grooves 25 are formed in the optical axis AX direction at the end of the substantially cylindrical main body portion 20a on the opposite side from the subject side, and move in a state of being engaged with the cam followers 17b provided to the sixth lens group unit 17. The cam grooves 25 each have a cam movement region 25a and an unused region 25b, as shown in FIG. 5.

The cam movement region 25a is the range over which the cam followers 17b of the sixth lens group unit 17 engage and move during imaging with the lens barrel 10, and are disposed running along a direction that intersects the optical axis AX.

The unused region 25b communicates with the cam movement region 25a, and is the region where the cutting tool moves from the cutting start point to cam movement region 25a during the cutting of the cam grooves 25. That is, the unused region 25b is the region where the cam follower 17b of the sixth lens group unit 17 does not move during imaging with the lens barrel 10.

As shown in FIGS. 2 and 3, the exterior unit 16 is a substantially cylindrical member that constitutes the exterior portion of the lens barrel 10, and on its outer peripheral surface, a circular zoom ring 16aa covered by a zoom ring rubber 16a, a focus ring 16ba covered by a focus ring rubber 16b, etc., are attached so as to be able to rotate in the circumferential direction.

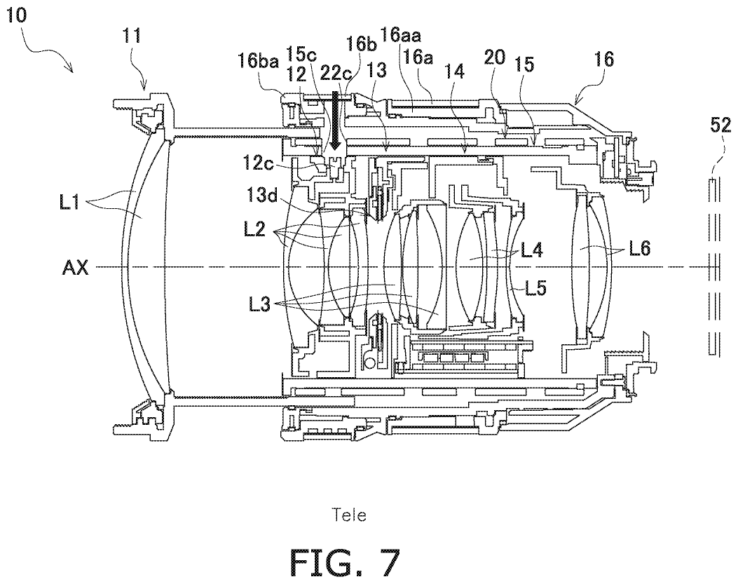

As shown in FIGS. 2 and 3, the zoom ring 16aa is a substantially annular member provided near the approximate center of the exterior unit 16 in the optical axis AX direction, and is turned to change the lens barrel 10 from the wide angle position (see FIG. 6, etc.) to the telephoto position (see FIG. 7, etc.). As the zoom ring 16aa rotates, the cam barrel 20 also rotates, causing the first lens group unit 11, the second lens group unit 12, the third lens group unit 13, the fourth and fifth lens group unit 14, and the sixth lens group unit 17 to move back and forth in the optical axis AX direction.

As shown in FIGS. 2 and 3, the focus ring 16ba is a substantially annular member provided on the outer peripheral surface of the exterior unit 16 at a position adjacent to the subject side of the zoom ring 16aa in the optical axis AX direction, and changes the position of the focus lenses (lenses L4 and L5) in the optical axis AX direction. As the focus ring 16ba is turned, the cam barrel 20 also rotates, thereby moving the fourth and fifth lens group unit 14 back and forth in the optical axis AX direction.

When various adjustments are made using a specific tool to the adjustment pins 12c, 13c, and 14c provided to the second lens group unit 12, the third lens group unit 13, and the fourth and fifth lens group unit 14 (discussed below), the zoom ring rubber 16a and focus ring rubber 16b, which are made of rubber and are provided so as to cover the zoom ring 16aa and focus ring 16ba, are removed.

### Adjustment of Second Lens Group Unit 12

With the lens barrel 10 of this embodiment, the procedure for adjusting the position (centering) of the second lens group unit 12 in a plane perpendicular to the optical axis AX and the inclination with respect to the optical axis AX will now be described with reference to FIGS. 6 to 8B.

When the lens barrel 10 is in the wide angle position shown in FIG. 6, the adjustment pins 12c provided to the second lens group unit 12 are exposed from the through-holes 15c of the rectilinear guide cylinder 15 when viewed from the outer peripheral side, but the portion near the cam groove 22 of the cam barrel 20 overlaps, and is completely covered by the first lens group unit 11.

Therefore, a tool is unable to access the adjustment pin 12c from the outer peripheral side (see the one-dot chain arrow in FIG. 6).

On the other hand, when the lens barrel 10 is in the telephoto position shown in FIG. 7, the adjustment pins 12c provided to the second lens group unit 12 are completely exposed, as viewed from the outer peripheral side, via the through-holes 15c of the rectilinear guide cylinder 15 and the through-holes 22c that communicate with the cam grooves 22 of the cam barrel 20 once the focus ring rubber 16b is removed.

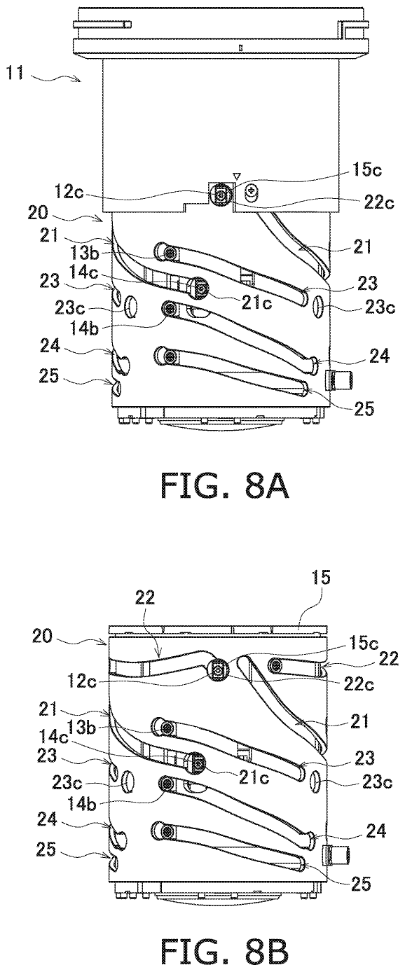

That is, when various adjustments are made by accessing the adjustment pin 12c of the second lens group unit 12 from the outer peripheral side with a specific tool, changing to the telephoto position shown in FIG. 7 causes the adjustment pin 12c of the second lens group unit 12 to be exposed when viewed from the outer peripheral side, as shown in FIGS. 8A and 8B.

Consequently, when adjusting the second lens group unit 12, the adjustment pins 12c can be accessed by inserting a specific tool through the through-holes 22c communicating with the cam grooves 22 that expose the adjustment pins 12c and the through-holes 15c of the rectilinear guide cylinder 15.

### Adjustment of Third Lens Group Unit 13

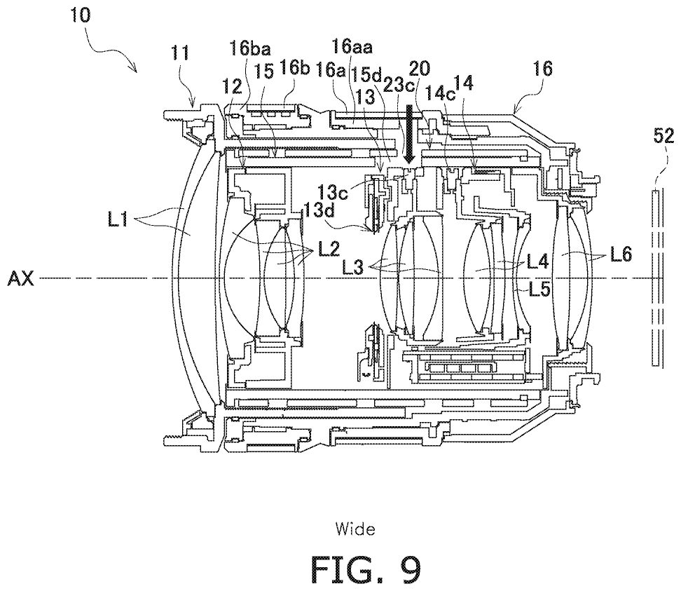

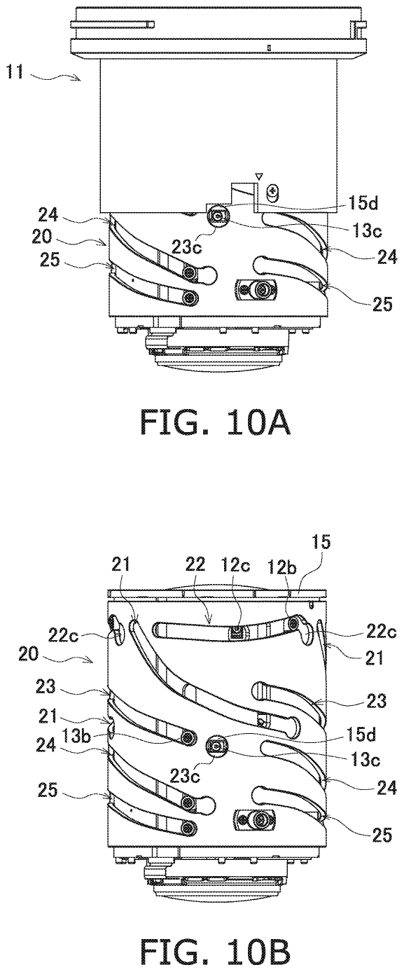

With the lens barrel 10 of this embodiment, the procedure for adjusting the position (centering) of the third lens group unit 13 in a plane perpendicular to the optical axis AX and the inclination with respect to the optical axis AX will now be described with reference to FIGS. 9 to 10B.

When the lens barrel 10 is in the wide angle position shown in FIG. 9, the adjustment pins 13c provided to the third lens group unit 13 are completely exposed, as viewed from the outer peripheral side, via the through-holes 15d of the rectilinear guide cylinder 15 and the through-holes 23c of the cam barrel 20 when the zoom ring rubber 16a is removed.

That is, when various adjustments are made by accessing the adjustment pin 13c of third lens group unit 13 from the outer peripheral side with a specific tool, changing to the wide angle position shown in FIG. 9 results in the adjustment pins 13c of third lens group unit 13 being exposed when viewed from the outer peripheral side, as shown in FIGS. 10A and 10B.

Consequently, when adjusting the third lens group unit 13, the adjustment pins 13c can be accessed by inserting a specific tool through the independent through-holes 23c that expose the adjustment pins 13c and the through-holes 15d of the rectilinear guide cylinder 15.

### Adjustment of Fourth and Fifth Lens Group Unit 14

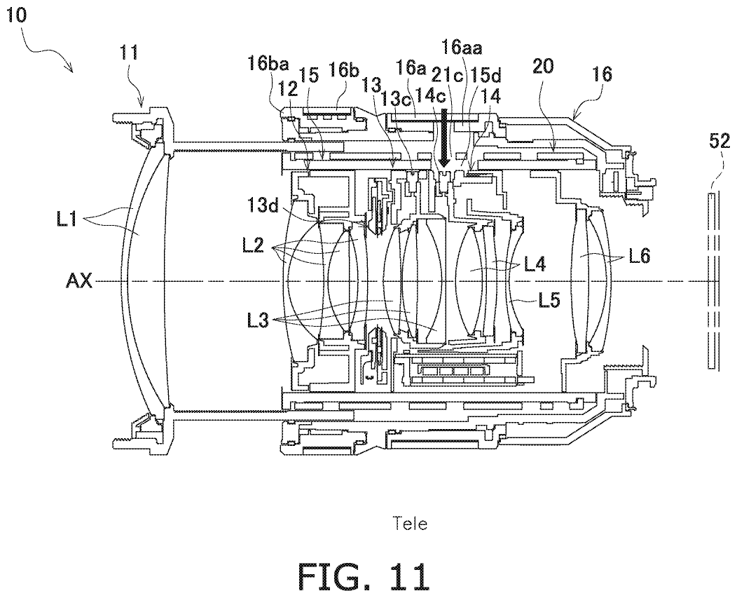

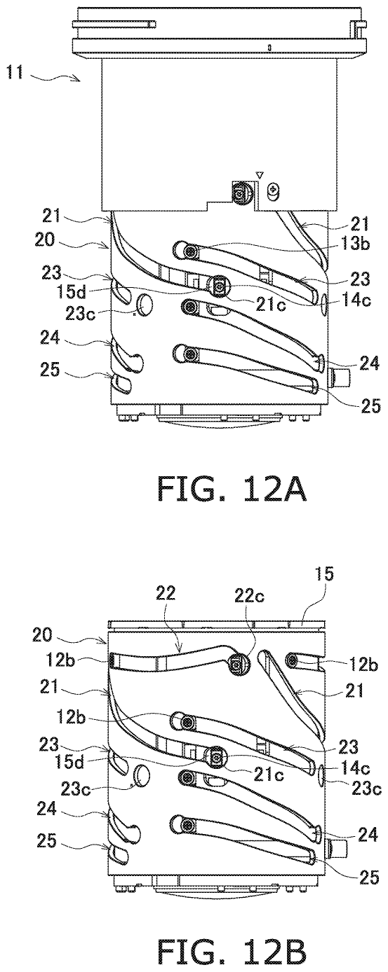

With the lens barrel 10 of this embodiment, the above-mentioned procedure for adjusting the position (centering) of the fourth and fifth lens group unit 14 in a plane perpendicular to the optical axis AX and the inclination with respect to the optical axis AX will now be described with reference to FIGS. 11 to 12B.

When the lens barrel 10 is in the telephoto position shown in FIG. 11, the adjustment pins 14c provided to the fourth and fifth lens group unit 14 are completely exposed, as viewed from the outer peripheral side, via the through-holes 15d of the rectilinear guide cylinder 15 and the through-holes 21c that communicate with the cam grooves 21 of the cam barrel 20 when the zoom ring rubber 16a is removed.

That is, when various adjustments are made by accessing the adjustment pins 14c of the fourth and fifth lens group unit 14 from the outer peripheral side with a specific tool, changing to the telephoto position shown in FIG. 11 results in the adjustment pins 14c of the fourth and fifth lens group unit 14 being exposed when viewed from the outer peripheral side, as shown in FIGS. 12A and 12B.

Consequently, when adjusting the fourth and fifth lens group unit 14, the adjustment pins 14c can be accessed by inserting a specific tool through the through-holes 21c communicating with the cam grooves 21 that expose the adjustment pins 14c and the through-holes 15d of the rectilinear guide cylinder 15.

In particular, with the lens barrel 10 of this embodiment, the through-holes 21c that communicate with the cam grooves 21 for driving a lens frame (first lens group unit 11) other than the fourth and fifth lens group unit 14 are used in order to expose the adjustment pins 14c of the fourth and fifth lens group unit 14 on the outer peripheral side.

Here again, various adjustments can be made while avoiding a decrease in the strength of the cam barrel 20, which is in contrast to a configuration in which three through-holes 23c are provided, each formed independently from the cam groove, as is the case with the through-holes 23c.

### Main Features

The lens barrel 10 of this embodiment includes the lens L2, the second lens group unit 12, the rectilinear guide cylinder 15, the adjustment pins 12c, the cam followers 12b, the cam barrel 20, and the through-holes 22c. The lens L2 includes one or more lenses. The second lens group unit 12 holds the lens L2. The rectilinear guide cylinder 15 has a substantially cylindrical main body portion 15a that surrounds the second lens group unit 12, and the rectilinear groove 15b that is formed along the optical axis AX so as to pass through the main body portion 15a, and the rectilinear guide cylinder 15 supports the second lens group unit 12 so as to be able to move along the optical axis AX. The adjustment pins 12c are provided to the second lens group unit 12, and work on the second lens group unit 12 is performed using a specific tool from the outside in the radial direction centered on the optical axis AX. The cam followers 12b are provided to the second lens group unit 12 and protrude radially outward around the optical axis AX. The cam barrel 20 has a substantially cylindrical main body portion 20a that surrounds the second lens group unit 12, and a plurality of cam grooves 21 to 25 including the cam grooves 22 that are provided to the main body portion 20a and move the second lens group unit 12 in the optical axis AX direction when the cam followers 12b are engaged with and rotates relative to rectilinear guide cylinder 15. The through-holes 22c are provided at a position communicating with the cam grooves 22 in the main body portion 20a of the cam barrel 20, and are disposed at a position overlapping the adjustment pins 12c when viewed from the outside in the radial direction centered on optical axis AX when work is being performed on the second lens group unit 12.

Consequently, the portion of the outer peripheral surface of the cam barrel 20 where the effective surface area (thickness) excluding holes and grooves can be smaller than with a configuration in which work-use through-holes 22c are provided at a position separate and independent from the cam grooves 22, thereby ensuring adequate strength of the cam barrel 20 while also ensuring adequate thickness of the cam barrel 20, which keeps the lens barrel 10 from becoming larger in size.

### Other Embodiments

An embodiment of the present disclosure was described above, but the present disclosure is not limited to or by the above embodiment, and various modifications are possible without departing from the gist of the disclosure.

### (A)

In the above embodiment, an example was given in which the adjustment pins 12c for adjusting the position of the second lens group unit (first lens group frame) 12 in a plane perpendicular to the optical axis AX and the inclination with respect to the optical axis was used as a working unit that performs work on the first lens group frame from the outer peripheral side of the lens barrel using a tool or the like. However, the present disclosure is not limited to this.

For example, the working portion may be a part where other operations such as screw tightening, adhesive bonding, etc., are performed, aside from adjusting the position in a plane perpendicular to the optical axis AX and the inclination relative to the optical axis.

### (B)

In the above embodiment, an example was given in which the second lens group unit 12 having the adjustment pins 12c was used a first lens group frame having a working portion where work is performed with a tool or the like from the outer peripheral side of the lens barrel. However, the present disclosure is not limited to this.

For example, the first lens group frame provided with the working portion may instead be a lens frame other than a second lens group unit.

Similarly, with the second lens frame equipped with a working portion (adjustment pins 14c) with which various operations are performed from the outer peripheral side using a tool or the like via the through-holes 21c provided at a position communicating with the cam grooves 21 for driving another lens frame (first lens group unit 11), this may be some other lens frame, and is not limited to the fourth and fifth lens group unit 14.

### (C)

In the above embodiment, an example was given in which the through-holes 22c provided to the cam barrel 20 to allow access to the adjustment pins 12c and the like of the second lens group unit 12 from the outer peripheral side were provided at the end of the cam grooves 22. However, the present disclosure is not limited to this.

For example, if a working portion such as an adjustment pin is smaller than the cam groove, it may be provided somewhere along the cam groove rather than at the end of the cam groove.

### (D)

In the above embodiment, an example was given in which the lens barrel 10 was changed to the telephoto end in order to move the through-holes 22c to a position of overlapping the adjustment pins 12c when various adjustments and other operations are performed on the adjustment pins 12c provided to the second lens group unit 12, via the through-holes 22c provided at a position that communicates with the cam grooves 22 for driving the second lens group unit 12. However, the present disclosure is not limited to this.

For example, the configuration may be such that the lens barrel is changed to the wide angle end in order to dispose the through-holes and the adjustment pins or other sch working portions so as to overlap when viewed from the outer peripheral side (the outside in the radial direction).

### (E)

In the above embodiment, an example was given in which the through-holes 22c, etc., provided to the cam barrel 20 to allow access to the adjustment pins 12c and the like of the second lens group unit 12 from the outer peripheral side were provided in the unused region (second region) 22b, etc., formed in the course of cutting the cam grooves 22 and the like of the cam barrel 20. However, the present disclosure is not limited to this.

For example, the through-holes may be disposed at a position that is unrelated to the unused region.

### (F)

In the above embodiment, an example was given in which the through-holes 21c, 22c, and 23c were formed by utilizing machining start holes formed when cutting a substantially cylindrical aluminum member in the course of forming the cam barrel 20. However, the present disclosure is not limited to this.

For example, in the lens barrel of the present disclosure, it is not essential to utilize machining start holes, and the through-holes may be formed at a position communicating with the cam grooves, regardless of whether or not there are any machining start holes.

### (G)

In the above embodiment, an example was given in which the through-holes 22c, etc., provided to the cam barrel 20 for accessing the adjustment pins 12c and the like of the second lens group unit 12 from the outer peripheral side had a diameter greater than the width of the cam grooves 22. However, the present disclosure is not limited to this.

For example, the diameter of the through-holes may be appropriately set according to the size of the adjustment pins or other such working portions, the size of the working tool, and so forth, regardless of the width of the cam grooves.

### (H)

In the above embodiment, an example was given in which all of the cam grooves 21 to 25 provided to the cam barrel 20 were provided as through-grooves. However, the present disclosure is not limited to this.

For example, the configuration may be such that the cam grooves with which the cam followers of the lens frame engage, which do not require access to working portions such as the adjustment pins mentioned above, are formed as concave grooves rather than through-grooves, and through-holes are provided only at the ends of the cam grooves.

### (I)

In the above embodiment, an example was given in which the cam barrel 20, in which the cam grooves 21 to 25 and the through-holes 21c to 23c, etc., were formed, was disposed on the outer peripheral surface side of the rectilinear guide cylinder 15. However, the present invention is not limited to this.

For example, the configuration may be such that the cam barrel may is disposed on the inner peripheral side of the rectilinear guide cylinder, that is, the rectilinear guide cylinder is disposed on the outer peripheral surface side of the cam barrel.

### (J)

In the above embodiment, an example was given in which the cam barrel 20 was formed by cutting a substantially cylindrical member made of aluminum, but the present disclosure is not limited to this.

For example, the cam barrel may be made of a metal other than aluminum.

Also, the cam barrel may be formed from a non-metal material (such as a resin, etc.).

### (K)

In the above embodiment, an example was given in which the configuration of the present disclosure was applied to the lens barrel 10 that was removably attached to the camera body 51. However, the present invention is not limited to this.

For example, the configuration of the present disclosure may be applied to a lens barrel that is fixed in a non-removable state to a camera body.

### Addenda

The above description of the embodiments discloses the following techniques.

### Technique 1

The lens barrel according to Technique 1 comprises:
a first lens group that has at least one lens;
a first lens frame that holds the first lens group;
a rectilinear guide cylinder that has a substantially cylindrical first main body portion surrounding the first lens frame, and a rectilinear groove formed along an optical axis direction so as to pass through the first main body portion, and that is configured to support the first lens frame so as to be movable in the optical axis direction;
a working portion that is provided to the first lens frame and on which work is performed on the first lens frame from a radially outer side centered on an optical axis, using a specific tool;
a first cam follower that is provided to the first lens frame and projects outward in a radial direction centered on the optical axis;
a cam barrel that has a substantially cylindrical second main body portion surrounding the first lens frame, and a plurality of cam grooves provided to the second main body portion and including a first cam groove that engages the first cam follower and is configured to move the first lens frame in the optical axis direction when the cam barrel rotates relative to the rectilinear guide cylinder; and
a through-hole that is provided at a position in the second main body portion of the cam barrel that communicates with the cam groove, and that is disposed at a position that overlaps the working portion, as viewed from the outside in the radial direction center ed on the optical axis, in a state in which work is being performed on the first lens frame.

### Technique 2

The lens barrel according to Technique 2 is the lens barrel according to Technique 1,
wherein the through-hole is provided at a position that communicates with the first cam groove in the plurality of cam grooves.

### Technique 3

The lens barrel according to Technique 3 is the lens barrel according to Technique 1 or 2, further comprising:
a second lens group that has at least one lens;
a second lens frame that holds the second lens group; and
a second cam follower that is provided to the second lens frame and protrudes outward in the radial direction centered on the optical axis;
wherein the cam barrel further has a second cam groove that is provided to the second main body portion and moves the second lens frame in the optical axis direction when the second cam follower engages with the second cam groove and the cam barrel rotates relative to the rectilinear guide cylinder.

### Technique 4

The lens barrel according to Technique 4 is the lens barrel according to Technique 3,
wherein the through-hole is provided at a position communicating with the second cam groove.

### Technique 5

The lens barrel according to Technique 5 is the lens barrel according to any of Techniques 1 to 4,
wherein the first cam groove has a first region in which the first cam follower moves when the first lens frame is moved back and forth in the optical axis direction, and a second region that is outside the first region.

### Technique 6

The lens barrel according to Technique 6 is the lens barrel according to Technique 5,
wherein the through-hole is provided in the second region.

### Technique 7

The lens barrel according to Technique 7 is the lens barrel according to any of Techniques 1 to 6,
wherein the width of the through-hole is greater than the width of the first cam groove.

### Technique 8

The lens barrel according to Technique 8 is the lens barrel according to any of Techniques 1 to 7,
wherein the through-hole is provided at an end of the first cam groove.

### Technique 9

The lens barrel according to Technique 9 is the lens barrel according to Technique 4,
wherein the second cam groove has a third region in which the second cam follower moves when the second lens frame is moved back and forth in the optical axis direction, and a fourth region that is outside the third region.

### Technique 10

The lens barrel according to Technique 10 is the lens barrel according to Technique 9,
wherein the through-hole is provided in the fourth region.

### Technique 11

The lens barrel according to Technique 11 is the lens barrel according to Technique 4,
wherein the width of the through-hole is greater than the width of the second cam groove.

### Technique 12

The lens barrel according to Technique 12 is the lens barrel according to Technique 4,
wherein the through-hole is provided at an end of the second cam groove.

### Technique 13

The lens barrel according to Technique 13 is the lens barrel according to any of Techniques 1 to 12,
wherein the cam barrel is formed from metal.

### Technique 14

The lens barrel according to Technique 14 is the lens barrel according to Technique 13,
wherein the through-hole is a machining start hole where machining for forming the cam groove in the cam barrel is started, or a hole in which the diameter of the machining start hole has been enlarged.

### Technique 15

The lens barrel according to Technique 15 is the lens barrel according to any of Techniques 1 to 14,
wherein the working portion is a portion where adjustment of the position of the first lens frame in a plane perpendicular to the optical axis, adjustment of the inclination with respect to the optical axis, screw tightening, and adhesive bonding are performed.

### Technique 16

The imaging device according to Technique 10 comprises:
the lens barrel according to any of Techniques 1 to 15; and
a camera body to which the lens barrel is attached.

### INDUSTRIAL APPLICABILITY

The lens barrel of the present disclosure exhibits the effect that adequate strength of a cam barrel provided with through-holes for work can be ensured, while maintaining the compact size of the lens barrel, and as such is widely applicable to various kinds of lens barrel mounted on an imaging device.

### REFERENCE SIGNS LIST

10 lens barrel
11 first lens group unit
12 second lens group unit (first lens frame)
12a main body portion
12b cam follower (first cam follower)
12c adjustment pin (working portion)
13 third lens group unit
13a main body portion
13b cam follower
13c adjustment pin (working portion)
13d aperture unit
14 fourth and fifth lens group unit (first lens group frame)
14a main body portion
14b cam follower (first cam follower)
14c adjustment pin (working portion)
15 rectilinear guide cylinder
15a main body portion
15b rectilinear groove
15c through-hole
15d through-hole
16 exterior unit
16a zoom ring rubber
16aa zoom ring
16b focus ring rubber
16ba focus ring
17 sixth lens group unit
17a main body portion
17b cam follower
20 cam barrel
20a main body portion
21 cam groove (second cam groove)
21a cam movement region (third region)
21b unused region (fourth region)
21c through-hole
22 cam groove (first cam groove)
22a cam movement region (first region)
22b unused region (second region)
22c through-hole
23 cam groove
23a cam movement region
23b unused region
23c through-hole
24 cam groove
24a cam movement region
24b unused region
25 cam groove
25a cam movement region
25b unused region
50 camera (imaging device)
51 camera body
52 imaging element
AX optical axis
L1 to L5 lenses

What is claimed is:

1. A lens barrel, comprising:
a first lens group that has at least one lens;
a first lens frame that holds the first lens group;
a rectilinear guide cylinder that has a substantially cylindrical first main body portion surrounding the first lens frame, and a rectilinear groove formed along an optical axis direction so as to pass through the first main body portion, and that is configured to support the first lens frame so as to be movable in the optical axis direction;
a working portion that is provided to the first lens frame and on which work is performed on the first lens frame from a radially outer side centered on an optical axis, using a specific tool;
a first cam follower that is provided to the first lens frame and projects outward in a radial direction centered on the optical axis;
a cam barrel that has a substantially cylindrical second main body portion surrounding the first lens frame, and a plurality of cam grooves provided to the second main body portion and including a first cam groove that engages the first cam follower and is configured to move the first lens frame in the optical axis direction when the cam barrel rotates relative to the rectilinear guide cylinder; and
a through-hole that is provided at a position in the second main body portion of the cam barrel that communicates with the cam groove, and that is disposed at a position that overlaps the working portion, as viewed from the outside in the radial direction center ed on the optical axis, in a state in which work is being performed on the first lens frame.

2. The lens barrel according to claim 1,
wherein the through-hole is provided at a position that communicates with the first cam groove in the plurality of cam grooves.

3. The lens barrel according to claim 1, further comprising:
a second lens group that has at least one lens;
a second lens frame that holds the second lens group; and
a second cam follower that is provided to the second lens frame and protrudes outward in the radial direction centered on the optical axis;
wherein the cam barrel further has a second cam groove that is provided to the second main body portion and moves the second lens frame in the optical axis direction when the second cam follower engages with the second cam groove and the cam barrel rotates relative to the rectilinear guide cylinder.

4. The lens barrel according to claim 3,
wherein the through-hole is provided at a position communicating with the second cam groove.

5. The lens barrel according to claim 1,
wherein the first cam groove has a first region in which the first cam follower moves when the first lens frame is moved back and forth in the optical axis direction, and a second region that is outside the first region.

6. The lens barrel according to claim 5,
wherein the through-hole is provided in the second region.

7. The lens barrel according to claim 1,
wherein a width of the through-hole is greater than a width of the first cam groove.

8. The lens barrel according to claim 1,
wherein the through-hole is provided at an end of the first cam groove.

9. The lens barrel according to claim 4,
wherein the second cam groove has a third region in which the second cam follower moves when the second lens frame is moved back and forth in the optical axis direction, and a fourth region that is outside the third region.

10. The lens barrel according to claim 9,
wherein the through-hole is provided in the fourth region.

11. The lens barrel according to claim 4,
wherein a width of the through-hole is greater than a width of the second cam groove.

12. The lens barrel according to claim 4,
wherein the through-hole is provided at an end of the second cam groove.

13. The lens barrel according to claim 1,
wherein the cam barrel is formed from metal.

14. The lens barrel according to claim 13,
wherein the through-hole is a machining start hole where machining for forming the cam groove in the cam barrel is started, or a hole in which a diameter of the machining start hole has been enlarged.

15. The lens barrel according to claim 1,
wherein the working portion is a portion where adjustment of the position of the first lens frame in a plane perpendicular to the optical axis, adjustment of an inclination with respect to the optical axis, screw tightening, and adhesive bonding are performed.

16. An imaging device, comprising:
the lens barrel according to claim 1; and
a camera body to which the lens barrel is attached.
